(19) United States
(12) Patent Application Publication
(10) Pub. No.: US 2025/0336599 A1
(43) Pub. Date: Oct. 30, 2025

(54) Resonant inductor integrated transformer module

(71) Applicant: Atum Co., Ltd., Seoul (KR)

(72) Inventor: Taeksoo HAN, Seoul (KR)

(21) Appl. No.: 19/181,347

(22) Filed: Apr. 17, 2025

(30) Foreign Application Priority Data
Apr. 29, 2024 (KR) 10-2024-0056530

(51) Int. Cl. H01F 30/06; H01F 27/02; H01F 27/28; H01F 27/32

(52) U.S. Cl. CPC H01F 30/06; H01F 27/022; H01F 27/2823; H01F 27/2885; H01F 27/324

(57) ABSTRACT

Provided is a resonant inductor integrated transformer module including: a transformer; and a first resonant inductor and a second resonant inductor as spiral coils located on one side and the other side of the transformer designed to resonate with capacitance in the transformer, wherein the transformer includes: a flat primary coil; and a flat secondary coil adapted to generate an induced current by an electric current applied to the primary coil, whereby the primary coil is formed by winding a first square-shaped adhesion type covered conductive wire in the form of a coil in such a way as to form a first hollow portion at the central portion thereof and the secondary coil is formed by winding a second square-shaped adhesion type covered conductive wire in the form of a coil in such a way as to form a second hollow portion at the central portion thereof.

### CROSS REFERENCE TO RELATED APPLICATION OF THE DISCLOSURE

The present application claims the benefit of Korean Patent Application No. 10-2024-0056530 filed in the Korean Intellectual Property Office on Apr. 29, 2024, the entire contents of which are incorporated herein by reference.

### BACKGROUND OF THE DISCLOSURE

### Field of the Disclosure

The present disclosure relates to a transformer.

### Background of the Related Art

A plug-in hybrid electric vehicle (PHEV) and an electric vehicle (EV) (hereinafter, referred to collectively as electric vehicle) are provided with a charger for charging a high-voltage battery that drives the motor of the vehicle with 200V AC, and the charger is called an on-board charger (OBC).

The OBC built in the electric vehicle is configured to have an inductor-inductor-capacitor (LLC) converter, and the LLC converter has a transformer for converting a high-frequency AC voltage into a higher voltage and physically insulating the 220V AC from the high-voltage battery.

However, the transformer and the inductor of the LLC converter of the OBC of the conventional electric vehicle are physically separated from each other, thereby disadvantageously causing the OBC of the electric vehicle to become bulky and increasing the man hour for mounting them on a printed circuit board (PCB).

### SUMMARY OF THE DISCLOSURE

Accordingly, the present disclosure has been made in view of the above-mentioned problems occurring in the related art, and it is an object of the present disclosure to provide a resonant inductor integrated transformer module that is capable of having resonant inductors provided in a transformer itself, so that the resonant inductors have resonance with the capacitance in the transformer itself, thereby providing the transformer with high efficiency and low heat.

It is another object of the present disclosure to provide a resonant inductor integrated transformer module that is capable of having resonant inductors integral with a transformer, so that a space occupied thereby becomes small, thereby being advantageous in designing circuits in a PCB, and if the circuits are designed to have the resonant inductors integral with the transformer, the number of parts and a size of the PCB are reduced.

It is yet another object of the present disclosure to provide a resonant inductor integrated transformer module that is capable of controlling the reflection characteristics of electromagnetic waves found at zero-crossing points.

It is still another object of the present disclosure to provide a resonant inductor integrated transformer module that is capable of emitting heat generated from a transformer, while the characteristics of the transformer and resonant inductors are being still kept, thereby improving heat emission efficiency of the transformer.

It is yet still another object of the present disclosure to provide a resonant inductor integrated transformer module that is capable of allowing primary and secondary coils of a transformer and resonant inductors to be shielded by magnetic cores, so that perfect resonance is generated, thereby improving the efficiency of the transformer and the temperature characteristics of the transformer.

It is another object of the present disclosure to provide a resonant inductor integrated transformer module that is capable of allowing primary and secondary coils to be formed by winding first and second square-shaped adhesion type covered conductive wires, which are made by shaping thin copper wires in the form of a square, covering insulating sheaths on the outer surfaces of the square-shaped thin copper wires, and applying bonding layers to the outer surfaces of the insulating sheaths, in such a way as to allow wound surfaces thereof to be brought into close contact with one another, and fusing and joining the wound surfaces of the first and second square-shaped adhesion type covered conductive wires, so that the primary and secondary coils have high degrees of contact on the wound surfaces thereof and a degree of space utilization for the same number of turns is higher than that when the primary and secondary coils are made with conventional wires.

It is yet another object of the present disclosure to provide a resonant inductor integrated transformer module that is capable of allowing a transformer for OBC to be reduced in volume, thereby decreasing the space occupied thereby on the OBC.

It is still another object of the present disclosure to provide a resonant inductor integrated transformer module that is capable of allowing the wound surfaces of primary and secondary coils to have high degrees of contact, so that a degree of space utilization for the same number of turns is higher than that when the primary and secondary coils are made with conventional wires, thereby minimizing a value of leakage current.

It is yet still another object of the present disclosure to provide a resonant inductor integrated transformer module that is capable of allowing no insulation breakdown to occur even at a high voltage in the range of several to tens of kV, while an efficiency between a primary coil and a secondary coil is being kept.

It is another object of the present disclosure to provide a resonant inductor integrated transformer module that is capable of supplying large current and high voltage even in small size.

To accomplish the above-mentioned objects, according to the present disclosure, there is provided a resonant inductor integrated transformer module including: a transformer; and a first resonant inductor and a second resonant inductor as spiral coils located on one side and the other side of the transformer in such a way as to resonate with capacitance in the transformer.

According to the present disclosure, desirably, the transformer may include: a flat primary coil having a first hollow portion at the central portion thereof; and a flat secondary coil adapted to generate an induced current by an electric current applied to the primary coil and having a second hollow portion at the central portion thereof, wherein the primary coil may be formed by winding a first square-shaped adhesion type covered conductive wire in the form of a coil in such a way as to form the first hollow portion at the central portion thereof, the first square-shaped adhesion type covered conductive wire including: stranded thin copper wires made up of multiple thin copper wires twisted together; a square thin copper wire bundle in which the thin copper wires are arrayed to come into close contact with one another in the form of a square; an insulating sheath covered on the outer surfaces of the square thin copper wire bundle; and a bonding layer as an adhesive applied to the outer surfaces of the insulating sheath, whereby the primary coil may be formed by winding the first square-shaped adhesion type covered conductive wire in such a way as to have multiple turns, while allowing the wound surfaces thereof to be brought into close contacts with one another, fusing and curing the applied bonding layer, and joining the close contact surfaces of the first square-shaped adhesion type covered conductive wire by means of the fusing.

According to the present disclosure, desirably, the secondary coil may be formed by winding a second square-shaped adhesion type covered conductive wire in the form of a coil in such a way as to form the second hollow portion at the central portion thereof, and the second square-shaped adhesion type covered conductive wire may include: stranded thin copper wires made up of multiple thin copper wires twisted together; a square thin copper wire bundle in which the thin copper wires are arrayed to come into close contact with one another in the form of a square; an insulating sheath covered on the outer surfaces of the square thin copper wire bundle; and a bonding layer as an adhesive applied to the outer surfaces of the insulating sheath, whereby the secondary coil may be formed by winding the second square-shaped adhesion type covered conductive wire in such a way as to have multiple turns, while allowing the wound surfaces thereof to be brought into close contacts with one another, fusing and curing the applied bonding layer, and joining the close contact surfaces of the second square-shaped adhesion type covered conductive wire by means of the fusing.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is a perspective view showing a resonant inductor integrated transformer module according to the present disclosure;

FIG. 2 is a front view showing the resonant inductor integrated transformer module according to the present disclosure;

FIG. 3 is a sectional view showing the resonant inductor integrated transformer module according to the present disclosure;

FIG. 4 is an exploded perspective view showing the resonant inductor integrated transformer module according to the present disclosure;

FIG. 5 is an exploded bottom perspective view showing main components such as a main housing, a main cover, a first core housing, a first core cover, a second core housing, and a second core cover of the resonant inductor integrated transformer module according to the present disclosure;

FIG. 6 is a perspective view showing primary and secondary coils and first and second resonant inductors of the resonant inductor integrated transformer module according to the present disclosure; and

FIGS. 7A to 7D are concept views showing first and second square-shaped adhesion type covered conductive wires constituting the primary and secondary coils and third and fourth square-shaped adhesion type covered conductive wires constituting the first and second resonant inductors of the resonant inductor integrated transformer module according to the present disclosure, wherein FIG. 7A shows the first to fourth square-shaped adhesion type covered conductive wires that are coated entirely with insulating sheaths, FIG. 7B shows the first to fourth square-shaped adhesion type covered conductive wires whose insulating sheaths are exposed partially to the outside; FIG. 7C shows the first to fourth square-shaped adhesion type covered conductive wires with bonding layers, and FIG. 7D shows stranded thin copper wires of the primary and secondary coils and the first and second resonant inductors that are made up of multiple thin copper wires twisted together.

### DETAILED DESCRIPTION OF THE PREFERRED EMBODIMENTS

Hereinafter, an explanation of a resonant inductor integrated transformer module according to an embodiment of the present disclosure will be given in detail with reference to the attached drawings.

If directions in the present disclosure are defined, as shown, a direction in which input portions 110i and 120i and output portions 110f and 120f of primary and secondary coils 110 and 120 are located represents a front side of a resonant inductor integrated transformer module 1 according to the present disclosure, and a left side direction in the drawing represents a left side of the resonant inductor integrated transformer module 1 according to the present disclosure.

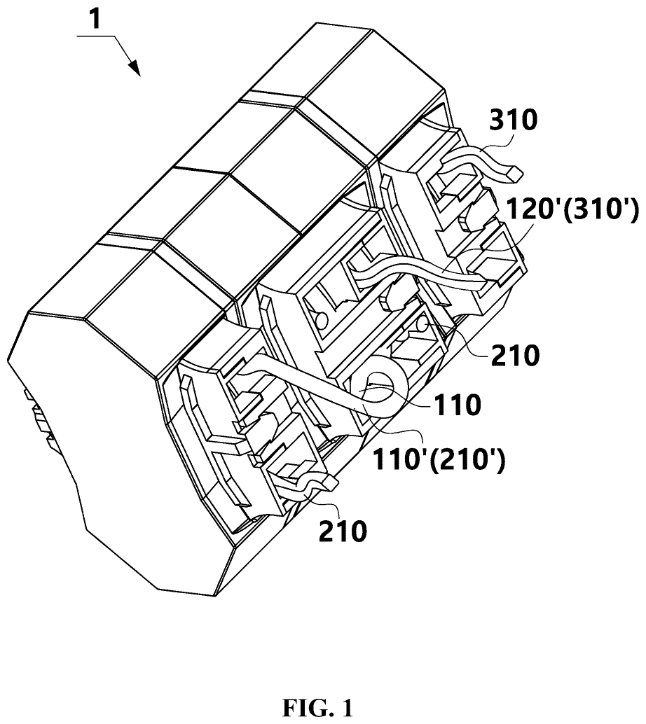

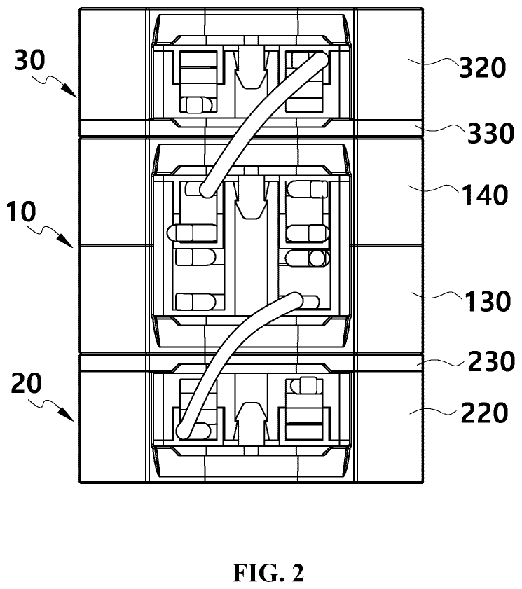

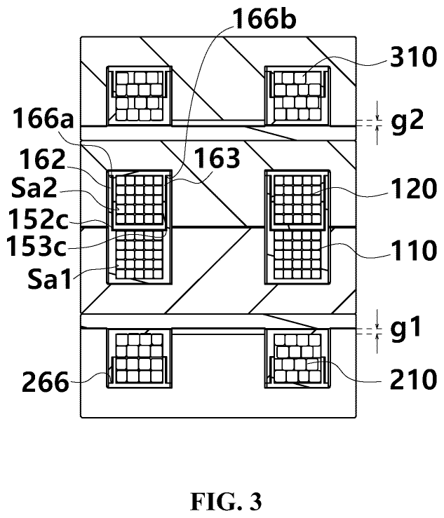

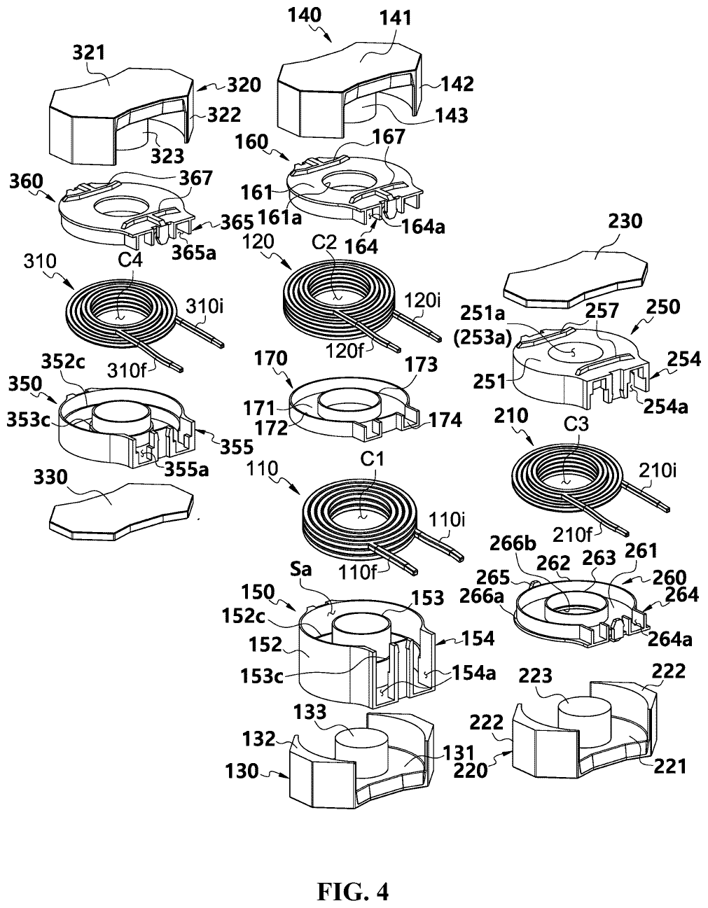

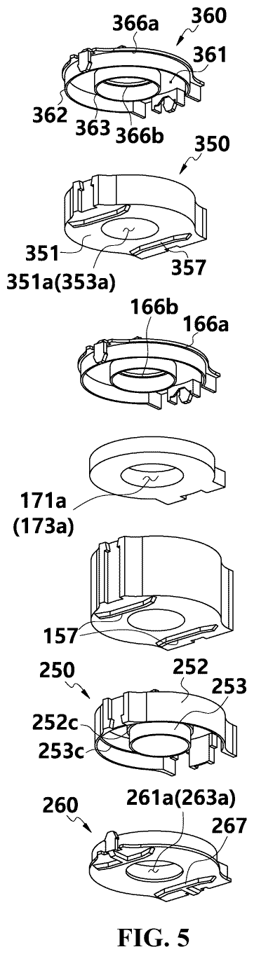

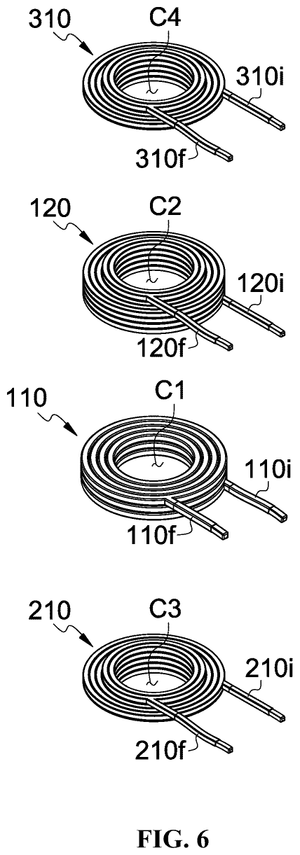

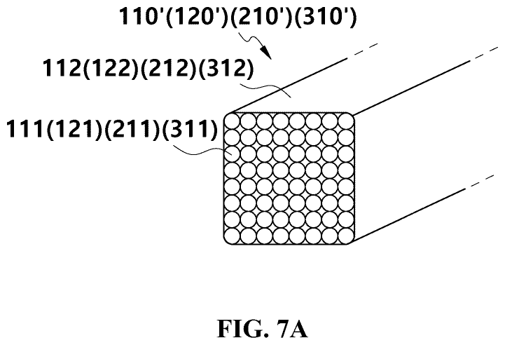

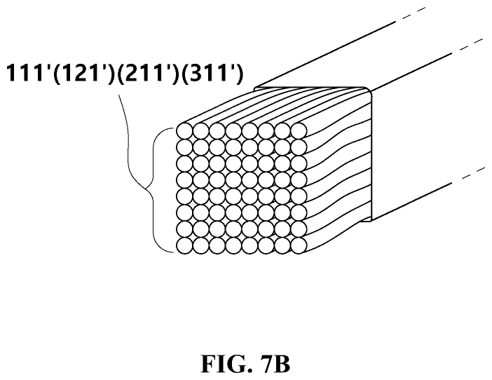

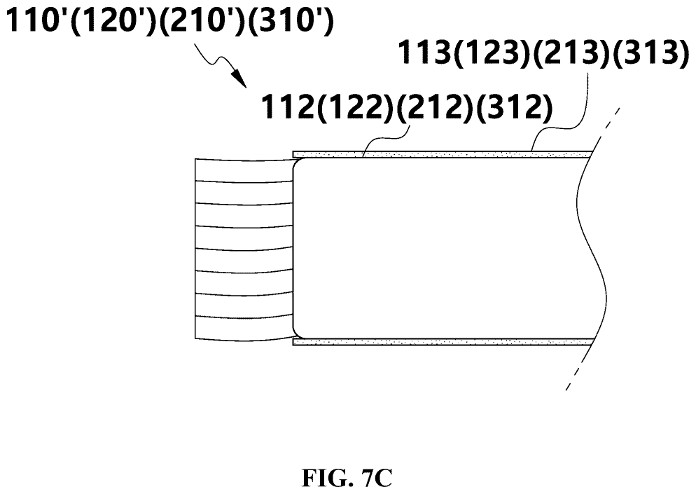

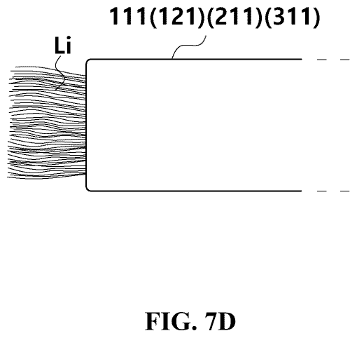

In FIGS. 1 to 6, thin copper wires 111 and 121 and bonding layers 113 and 123 for first and second square-shaped adhesion type covered conductive wires 110′ and 120′ forming the primary and second coils 110 and 120 are not shown in detail, and further, thin copper wires 211 and 311 and bonding layers 213 and 313 for third and fourth square-shaped adhesion type covered conductive wires 210′ and 310′ forming first and second resonant inductors 210 and 310 are not shown in detail. The first and second square-shaped adhesion type covered conductive wires 110′ and 120′ forming the primary and second coils 110 and 120 and the third and fourth square-shaped adhesion type covered conductive wires 210′ and 310′ forming the first and second inductors 210 and 310, as shown in FIGS. 1 to 6, are configured as shown in FIGS. 7A to 7D.

The resonant inductor integrated transformer module 1 according to the present disclosure includes a transformer 10 and resonant inductors 210 and 310 located on one side and the other side of the transformer 10 in the form of spiral coils in such a way as to resonate with capacitance Cp in the transformer 10 itself.

The transformer 10 includes the primary coil 110 that is flat and has a first hollow portion C1 at the central portion thereof and the secondary coil 120 that is flat, generates an induced current by an electric current applied to the primary coil 110, and has a second hollow portion C2 at the central portion thereof.

The primary coil 110 is formed by winding the first square-shaped adhesion type covered conductive wire 110′ in the form of a coil in such a way as to form the first hollow portion C1 at the central portion thereof, and the first square-shaped adhesion type covered conductive wire 110′ includes stranded thin copper wires 111 made up of multiple thin copper wires Li twisted together, a square thin copper wire bundle 111′ in which the stranded thin copper wires 111 are arrayed to come into close contact with one another in the form of a square, an insulating sheath 112 covered on the outer surfaces of the square thin copper wire bundle 111′, and the bonding layer 113 as an adhesive applied to the outer surfaces of the insulating sheath 112.

In detail, the primary coil 110 is formed by winding the first square-shaped adhesion type covered conductive wire 110′ in such a way as to have multiple turns by means of a winding member (not shown), while allowing the wound surfaces thereof to be brought into close contacts with one another, fusing and curing the applied bonding layer 113 by means of application of a solvent (e.g., alcohol) or heat (hot air), and joining the close contact surfaces of the first square-shaped adhesion type covered conductive wire 110′ by means of the fusing.

The secondary coil 120 is formed by winding the second square-shaped adhesion type covered conductive wire 120′ in the form of a coil in such a way as to form the second hollow portion C2 at the central portion thereof, and the second square-shaped adhesion type covered conductive wire 120′ includes stranded thin copper wires 121 made up of multiple thin copper wires Li twisted together, a square thin copper wire bundle 121′ in which the thin copper wires 121 are arrayed to come into close contact with one another in the form of a square, an insulating sheath 122 covered on the outer surfaces of the square thin copper wire bundle 121′, and the bonding layer 123 as an adhesive applied to the outer surfaces of the insulating sheath 122.

In detail, the secondary coil 120 is formed by winding the second square-shaped adhesion type covered conductive wire 120′ in such a way as to have multiple turns by means of a winding member (not shown), while allowing the wound surfaces thereof to be brought into close contacts with one another, fusing and curing the applied bonding layer 123 by means of application of a solvent (e.g., alcohol) or heat (hot air), and joining the close contact surfaces of the second square-shaped adhesion type covered conductive wire 120′ by means of the fusing.

The resonant inductors 210 and 310 are resonant coils for resonance.

As the resonant inductors 210 and 310 are located inside the transformer 10 itself, they resonate with the capacitance in the transformer 10 itself.

Furthermore, as the resonant inductors 210 and 310 are integral with the transformer 10, a space occupied thereby becomes small, thereby being advantageous in designing circuits in a PCB, and if the circuits are designed to allow the resonant inductors 210 and 310 to be integral with the transformer 10, the number of parts and a size of the PCB are reduced.

As the resonant inductors 210 and 310 and the transformer 10 are configured as one module, a manufacturing cost of a product is reduced.

Under the configuration wherein the transformer 10 and the resonant inductors 210 and 310 are integral with one another, the primary and secondary coils 110 and 120 are formed by joining, by means of fusing, the first and second square-shaped adhesion type covered conductive wires 110′ and 120′ that are made by shaping the thin copper wires 111 and 121 to the form of square, covering the insulating sheaths 112 and 122 on the outer surfaces of the thin copper wires 111 and 121, and forming the bonding layers 113 and 123 on the insulating sheaths 112 and 122, while allowing the wound portions thereof to be brought into close contacts with one another, so that the wound portions of the primary and secondary coils 110 and 120 have high degrees of contact, and further, a degree of space utilization for the same number of turns is higher than that when the primary and secondary coils 110 and 120 are made with the conventional wires. Therefore, the transformer is reduced in volume, thereby decreasing the space occupied thereby on a main board (e.g., on board charger (OBC) for mounting it.

As a degree of space utilization for the same number of turns is higher than that when the primary and secondary coils 110 and 120 are made with the conventional wires, advantageously, a value of leakage current is minimized.

Accordingly, no insulation breakdown occurs even at a high voltage in the range of several to tens of kV, while an efficiency between the primary coil 110 and the secondary coil 120 is being kept.

Under the above-mentioned configurations of the primary coil 110 and the secondary coil 120, the primary coil 110 and the secondary coil 120 supply large current and high voltage even if they are small in size.

Further, the primary coil 110 and the secondary coil 120 of the transformer 10 are formed by means of fusing, so that the wound portions of the primary coil 110 and the secondary coil 120 have high degrees of contact, and further, a degree of contact between the primary coil 110 and the secondary coil 120 is improved, so that a loss therebetween is reduced to improve the efficiency therebetween. Further, the transformer as a product is reduced in height, thereby becoming compact in size.

As the height and size of the transformer 10 are reduced, the finished product (e.g., OBC) where the transformer 10 is mounted decreases in size, so that the space occupied by the OBC in the electric vehicle becomes small and the finished product is lightweight, thereby improving the product competitiveness of the OBC of the electric vehicle.

Further, the primary coil 110 and the secondary coil 120 of the transformer 10 are made by means of a winding jig or winder, which makes it possible to automatedly produce the primary coil 110 and the secondary coil 120 of the transformer 10, so that the number of assembling processes is reduced, thereby greatly improving their productivity and price competitiveness.

The winding member is a winding jig or winder.

The adhesive is an adhesive paint.

The square thin copper wire bundle 111′ constituting the first square-shaped adhesion type covered conductive wire 110′ is formed by arraying the thin copper wires 111 in up-down and left-right directions in the form of a square in such a way as to be brought into close contact with one another, and the square thin copper wire bundle 121′ constituting the second square-shaped adhesion type covered conductive wire 120′ is formed by arraying the thin copper wires 121 in up-down and left-right directions in the form of a square in such a way as to be brought into close contact with one another.

In this case, the square thin copper wire bundles 111′ and 121′ are in the form of the square, as shown, and otherwise, they may be in the form of a rectangle.

The shapes of the square thin copper wire bundles 111′ and 121′ of the first and second square-shaped adhesion type covered conductive wires 110′ and 120′ are made when the square thin copper wire bundles 111′ and 121′ pass through a square roller.

The insulating sheaths 112 and 122 are insulation tapes.

The resonant inductor 210 represents a first resonant inductor located on one side of the transformer 10, and the resonant inductor 310 represents a second resonant inductor located on the other side of the transformer 10.

The first resonant inductor 210 is formed by winding the third square-shaped adhesion type covered conductive wire 210′ in the form of a coil in such a way as to form a third hollow portion C3 at the central portion thereof, and the third square-shaped adhesion type covered conductive wire 210′ includes stranded thin copper wires 211 made up of multiple thin copper wires Li twisted together, a square thin copper wire bundle 211′ in which the thin copper wires 111 are arrayed to come into close contact with one another in the form of a square, an insulating sheath 212 covered on the outer surfaces of the square thin copper wire bundle 211′, and the bonding layer 213 as an adhesive applied to the outer surfaces of the insulating sheath 212.

In this case, the first resonant inductor 210 is formed by winding the third square-shaped adhesion type covered conductive wire 210′ in such a way as to have multiple turns by means of a winding member (not shown), while allowing the wound surfaces thereof to be brought into close contacts with one another, fusing and curing the applied bonding layer 213 by means of application of a solvent (e.g., alcohol) or heat (hot air), and joining the close contact surfaces of the third square-shaped adhesion type covered conductive wire 210′ by means of the fusing.

Further, the second resonant inductor 310 is formed by winding the fourth square-shaped adhesion type covered conductive wire 310′ in the form of a coil in such a way as to form a fourth hollow portion C4 at the central portion thereof, and the fourth square-shaped adhesion type covered conductive wire 310′ includes stranded thin copper wires 311 made up of multiple thin copper wires Li twisted together, a square thin copper wire bundle 311′ in which the thin copper wires 311 are arrayed to come into close contact with one another in the form of a square, an insulating sheath 312 covered on the outer surfaces of the square thin copper wire bundle 311′, and the bonding layer 313 as an adhesive applied to the outer surfaces of the insulating sheath 312.

Further, the second resonant inductor 310 is formed by winding the fourth square-shaped adhesion type covered conductive wire 310′ in such a way as to have multiple turns by means of a winding member (not shown), while allowing the wound surfaces thereof to be brought into close contacts with one another, fusing and curing the applied bonding layer 313 by means of application of a solvent (e.g., alcohol) or heat (hot air), and joining the close contact surfaces of the fourth square-shaped adhesion type covered conductive wire 310′ by means of the fusing.

The resonant inductor integrated transformer module 1 according to the present disclosure is configured, using the first square-shaped adhesion type covered conductive wire 110′ and the third square-shaped adhesion type covered conductive wire 210′ that are provided as a single conductive wire, to allow the primary coil 110 to be formed by winding the first square-shaped adhesion type covered conductive wire 110′ in the form of a coil in such a way as to form the first hollow portion C1 at the central portion thereof and allow the first resonant inductor 210 extending from the primary coil 110 to be formed by winding the third square-shaped adhesion type covered conductive wire 210′ in the form of a coil in such a way as to form the third hollow portion C3 at the central portion thereof, so that the first resonant inductor 210 and the primary coil 110 are connected in series with each other.

The connection between the first resonant inductor 210 and the primary coil 110 in series is made not by making and connecting the respective conductive wires, independently of each other, but by connecting the output portion 210f of the first resonant inductor 210 to the input portion 110i of the primary coil 110 using the single conductive wire.

The resonant inductor integrated transformer module 1 according to the present disclosure is configured, using the second square-shaped adhesion type covered conductive wire 120′ and the fourth square-shaped adhesion type covered conductive wire 310′ that are provided as a single conductive wire, to allow the secondary coil 120 to be formed by winding the second square-shaped adhesion type covered conductive wire 120′ in the form of a coil in such a way as to form the second hollow portion C2 at the central portion thereof and allow the second resonant inductor 310 extending from the secondary coil 120 to be formed by winding the fourth square-shaped adhesion type covered conductive wire 310′ in the form of a coil in such a way as to form the fourth hollow portion C4 at the central portion thereof, so that the second resonant inductor 310 and the secondary coil 120 are connected in series with each other.

The connection between the second resonant inductor 310 and the secondary coil 120 in series is made not by making and connecting the respective conductive wires, independently of each other, but by connecting the output portion 120f of the secondary coil 120 to the input portion 310f of the second resonant inductor 210 using the single conductive wire.

Like this, the input portion 210i of the first resonant inductor 210 and the output portion 110f of the primary coil 110 are wound to be arranged in the same direction as each other, and the input portion 320i of the second resonant inductor 320 and the output portion 120f of the secondary coil 120 are wound to be arranged in the same direction as each other.

Like this, the primary coil 110, the secondary coil 120, the first resonant inductor 210, and the second resonant inductor 310 of the transformer module 1 are connected in series with one another as a single assembly, thereby reducing a height and size of the transformer module 1. Further, a loss between the primary coil 110 and the secondary coil 120 is reduced, thereby enhancing the efficiency of the transformer 10.

Further, the square thin copper wire bundle 211′ constituting the third square-shaped adhesion type covered conductive wire 210′ is formed by arraying the thin copper wires 211 in up-down and left-right directions in the form of a square in such a way as to be brought into close contact with one another, and the square thin copper wire bundle 311′ constituting the fourth square-shaped adhesion type covered conductive wire 310′ is formed by arraying the thin copper wires 311 in up-down and left-right directions in the form of a square in such a way as to be brought into close contact with one another.

In this case, the square thin copper wire bundles 211′ and 311′ are in the form of the square, as shown, and otherwise, they may be in the form of a rectangle.

The shapes of the square thin copper wire bundles 211′ and 311′ of the third and fourth square-shaped adhesion type covered conductive wires 210′ and 310′ are made when the square thin copper wire bundles 211′ and 311′ pass through a square roller.

Desirably, the insulating sheaths 312 and 322 are insulation tapes. More desirably, they are Kapton tapes.

The resonant inductor integrated transformer module 1 according to the present disclosure further includes first resonant magnetic cores 220 and 230 located on the first resonant inductor 210 to increase a magnetic flux density generated by the electric current applied to the first resonant inductor 210 and second resonant magnetic cores 320 and 330 located on the second resonant inductor 310 to increase a magnetic flux density generated by the electric current applied to the second resonant inductor 310.

The reflection characteristics of electromagnetic waves are found at zero-crossing points, and as the first resonant magnetic cores 220 and 230 and the second resonant magnetic cores 320 and 330 are located on the first resonant inductor 210 and the second resonant inductor 310, therefore, such reflection characteristics can be controlled advantageously.

The transformer 10 further includes main magnetic cores 130 and 140 located on the primary and secondary coils 110 and 120 to increase magnetic flux densities generated by induced currents.

In detail, the main magnetic core 130 represents a first main magnetic core located on the primary coil 110, and the main magnetic core 140 represents a second main magnetic core located on the secondary coil 120.

The first resonant magnetic cores 220 and 230 whose inner surfaces (tops in the drawings) facing the transformer 10 are brought into close contact with the outer surface (underside in the drawings) of the first main magnetic core 130, and the second resonant magnetic cores 320 and 330 whose inner surfaces (undersides in the drawings) facing the transformer 10 are brought into close contact with the outer surface (top in the drawings) of the second main magnetic core 140.

As a result, the heat generated from the transformer 10 is emitted, while the characteristics of the transformer 10 and the first and second resonant inductors 210 and 310 are being still kept, thereby improving heat emission efficiency of the transformer 10.

Further, the primary and secondary coils 110 and 120 and the first and second resonant inductors 210 and 310 are shielded by the magnetic cores 130, 140, 220, 230, 320, and 330, and simultaneously, the first and second main magnetic cores 130 and 140 are brought into close contact with the first and second resonant magnetic cores 220, 230, 320, and 330, so that perfect resonance is generated, thereby improving the efficiency of the transformer 10 and achieving excellent temperature characteristics of the transformer 10.

The first main magnetic core 130 includes a first main base 131 having the shape of a flat plate, first main outer legs 132 protruding from both outer edges of the first main base 131, and a first main middle leg 133 spaced apart from the first main outer legs 132 in such a way as to protrude from a central portion of the first main base 131 and be inserted into the first hollow portion C1 of the primary coil 110.

The second main magnetic core 140 includes a second main base 141 having the shape of a flat plate, second main outer legs 142 protruding from both outer edges of the second main base 141, and a second main middle leg 143 spaced apart from the second main outer legs 142 in such a way as to protrude from a central portion of the second main base 141 and be inserted into the second hollow portion C2 of the secondary coil 120.

The first resonant magnetic core 220 represents a first resonant magnetic outer core, and the second resonant magnetic core 230 represents a second resonant magnetic inner core. In detail, the first resonant magnetic outer core 220 includes a first resonant base 221 having the shape of a flat plate, first resonant outer legs 222 protruding from both outer edges of the first resonant base 221, and a first resonant middle leg 223 spaced apart from the first resonant outer legs 222 in such a way as to protrude from a central portion of the first resonant base 221 and be inserted into the third hollow portion C3 of the first resonant inductor 210, and the first resonant inner core 230 has the shape of a flat plate coming into close contact with the first main base 131 and is brought into close contact with the first resonant middle leg 223 and the first resonant outer legs 222 of the first resonant outer core 220 to form a closed magnetic flux. Further, a first air gap g1 is formed between the middle leg 223 of the first resonant outer core 220 and the first resonant inner core 230.

The second resonant magnetic core 320 represents a second resonant magnetic outer core, and the second resonant magnetic core 330 represents a second resonant magnetic inner core. In detail, the second resonant outer core 320 includes a second resonant base 321 having the shape of a flat plate, second resonant outer legs 322 protruding from both outer edges of the second resonant base 321, and a second resonant middle leg 323 spaced apart from the second resonant outer legs 322 in such a way as to protrude from a central portion of the second resonant base 321 and be inserted into the fourth hollow portion C4 of the second resonant inductor 310, and the second resonant inner core 330 has the shape of a flat plate coming into close contact with the second main base 141 and is brought into close contact with the second resonant middle leg 323 and the second resonant outer legs 322 of the second resonant outer core 320 to form a closed magnetic flux. Further, a second air gap g2 is formed between the middle leg 323 of the second resonant outer core 320 and the second resonant inner core 330.

Like this, the first and second air gaps g1 and g2 are formed between the middle legs 223 and 323 of the first and second resonant outer cores 220 and 320 and the first and second resonant inner cores 230 and 330, thereby allowing perfect resonance to be generated in the resonant inductors 210 and 310.

The first and second resonant outer cores 220 and 320 are rectangular modulus (RM) type cores.

The first and second air gaps g1 and g2 are preferably in the range of 0.9 to 1.3 mm, more preferably in the range of 1.0 to 1.2 mm.

An air gap may be formed between the middle leg of the first main magnetic core 130 and the middle leg of the second main magnetic core 140.

The resonant inductor integrated transformer module 1 according to the present disclosure further includes: a main housing 150 made of a synthetic resin, inserted into a space between the middle legs 133 and 143 and the outer legs 132 and 142 of the first and second main magnetic cores 130 and 140, and having a main insertion space Sa therein to insert the primary coil 110 and the secondary coil 120 thereinto; a main cover 160 made of a synthetic resin and fastened to the main housing 150 in such a way as to open and close the main insertion space Sa of the main housing 150; a shielding mount 170 made of a synthetic resin and located in the main insertion space Sa to dividedly partition the primary coil 110 and the secondary coil 120 so that the primary coil 110 and the secondary coil 120 are insulated from each other; a first core housing 250 made of a synthetic resin and inserted into a space between the middle leg 223 and the outer legs 222 of the first resonant magnetic core 220, while inserting the first resonant inductor 210 into an inner space thereof; a first core cover 260 made of a synthetic resin and fastened to the first core housing 250 in such a way as to open and close the inner space of the first core housing 250; a second core housing 350 made of a synthetic resin and inserted into a space between the middle leg 323 and the outer legs 322 of the second resonant magnetic core 320, while inserting the second resonant inductor 310 into an inner space thereof; and a second core cover 360 made of a synthetic resin and fastened to the second cire housing 350 in such a way as to open and close the inner space of the second core housing 350.

The primary coil 110 and the secondary coil 120 are fixed to the main insertion space Sa, without any movements, by means of an inwardly applied force (that is, attractive force) between the main housing 150 and the main cover 160.

The first inductor coil 210 is fixed to the inner space between the first core housing 250 and the first core cover 260, without any movements, by means of an inwardly applied force between the first core housing 250 and the first core cover 260.

The second inductor coil 310 is fixed to the inner space between the second core housing 350 and the second core cover 360, without any movements, by means of an inwardly applied force between the second core housing 350 and the second core cover 360.

The main housing 150 includes a flat main bottom 151 having a central hole 151a formed thereon, an outer wall 152 protruding upward from the outer periphery of the bottom 151, a support pipe 153 protruding upward from the inner periphery of the central hole 151a to form the main insertion space Sa between the outer periphery thereof and the outer wall 152 and having a through hole 153a communicating with the central hole 151a, and a conductive wire guide block 154 having a pair of input and output channels 154a through which the first square-shaped adhesion type covered conductive wire 110′ and the second square-shaped adhesion type covered conductive wire 120′ are inserted and drawn in the front side direction in such a way as to stably guide the input and output portions 110i, 110f, 120i, and 120f of the primary coil 110 and the secondary coil 120 therethrough in the front side direction.

The shielding mount 170 includes a circular flat bottom 171 having a central hole 171a formed thereon, an outer wall 172 protruding upward from the outer periphery of the bottom 171, and a support pipe 173 protruding upward from the inner periphery of the central hole 171a of the bottom 171 to form an insertion space Sb between the outer periphery thereof and the outer wall 172 and having a through hole 173a communicating with the central hole 171a.

The main cover 160 includes a circular flat plate 161 having a central hole 161a formed thereon, an outer wall 162 spaced apart from the outer periphery of the plate 161 toward the inner periphery in a radial direction and protruding vertically from the plate 161, a support pipe 163 protruding vertically from the inner periphery of the central hole 161a and having a through hole 163a communicating with the central hole 161a, and a conductive wire guide block 164 fitted to the conductive wire guide block 154 of the main housing 150 and having a pair of input and output channels 164a through which the second square-shaped adhesion type covered conductive wire 120′ is inserted and drawn in the front side direction in such a way as to stably guide the input and output portions 120i and 120f of the secondary coil 120 therethrough.

As the outer wall 162 of the main cover 160 is spaced apart from the outer periphery of the plate 161 toward the inner periphery in the radial direction, the main cover 160 has an outer support rib 166a along the outer periphery of the plate 161 in such a way as to fittedly support the outer wall 152, and as the support pipe 163 of the main cover 160 is spaced apart from the inner periphery of the central hole 161a toward the outer periphery in the radial direction, further, the main cover 160 has an inner support rib 166b formed along the inner periphery of the plate 161 in such a way as to fittedly support the support pipe 153 of the main housing 150.

Further, the main housing 150 has an outer support projection 152a on the inner peripheral surface of the outer wall 152 and an inner support projection 153a on the inner peripheral surface of the support pipe 153, so that as the outer wall 152 is supported against the outer support projection 152a and the support pipe 153 is supported against the inner support projection 153, the shielding mount 170 is mounted on the main housing 150 in such a way as to divide the main insertion space Sa into a lower insertion space Sal and an upper insertion space Sa2.

The outer support rib 166a and the inner support rib 166b of the main cover 160 are supportedly brought into close contact with the outer wall 152 and the support pipe 153 of the main housing 160, together, and the outer wall 162 and the support pipe 163 of the main cover 160 are supported against the outer wall 172 and the support pipe 173 of the shielding mount 170. Further, the outer wall 152 of the main housing 150 is fitted doubly to the outer wall 162 of the main cover 160 and the outer wall 172 of the shielding mount 170, and the support pipe 153 of the main housing 150 is inserted doubly into the support pipe 163 of the main cover 160 and the support pipe 173 of the shielding mount 170.

Further, the shielding mount 170 is located firmly in the main insertion space Sa by means of the inward fastening force (attractive force) between the main housing 150 and the main cover 160, and the primary coil 110 is located in the lower insertion space Sa1, while the secondary coil 120 is being located in the upper insertion space Sa2.

Under such a simple configuration, the primary coil 110 and the secondary coil 120 are inserted into the main housing 150, without any movements or gaps, while being reliably insulated from each other.

Further, the main cover 160 and the shielding mount 170 are stably mounted in the main housing 150.

The first core housing 250 includes a circular flat first plate 251 having a first central hole 251a formed thereon, a first outer wall 252 protruding vertically from the outer periphery of the first plate 251 toward the first resonant inductor 210, a first support pipe 253 protruding upward from the inner periphery of the first central hole 251a to form an insertion space between the outer periphery thereof and the first outer wall 252 and having a first through hole 253a communicating with the first central hole 251a, and a first conductive wire guide block 254 having a pair of input and output channels 254a through which the third square-shaped adhesion type covered conductive wire 210′ is inserted and drawn in the front side direction in such a way as to stably guide the input and output portions 210i and 210f of the third square-shaped adhesion type covered conductive wire 210′ of the first resonant inductor 210 therethrough.

The first core cover 260 includes a circular flat first cover plate 261 having a first cover central hole 261a formed thereon, a first cover outer wall 262 spaced apart from the outer periphery of the first cover plate 261 toward the inner periphery in a radial direction and protruding vertically from the first cover plate 261, a first cover support pipe 263 protruding vertically from the inner periphery of the first cover central hole 261a to form an insertion space between the outer periphery thereof and the first cover outer wall 262 and having a first cover through hole 263a communicating with the first cover central hole 261a, and a first cover conductive wire guide block 264 fitted to the first conductive wire guide block 254 and having a pair of input and output channels 264a through which the third square-shaped adhesion type covered conductive wire 210′ is inserted and drawn in the front side direction in such a way as to stably guide the input and output portions 210i and 210f of the third square-shaped adhesion type covered conductive wire 210′ of the first resonant inductor 210 therethrough.

As the first cover outer wall 262 of the first core cover 260 is spaced apart from the outer periphery of the first cover plate 261 toward the inner periphery in the radial direction, the first core cover 260 has a first cover outer support rib 266a along the outer periphery of the first cover plate 261 in such a way as to fittedly support the first outer wall 252, and as the first cover support pipe 263 of the first core cover 260 is spaced apart from the inner periphery of the first cover central hole 261a toward the outer periphery in the radial direction, further, the first core cover 260 has a first cover inner support rib 266b along the inner periphery of the first cover plate 261 in such a way as to fittedly support the first support pipe 253.

The first outer wall 252 has an outer support projection 252c on the inner peripheral surface thereof, and the first support pipe 253 has an inner support projection 253c on the inner peripheral surface thereof.

The first cover outer support rib 266a and the first cover inner support rib 266b of the first core cover 260 are fittedly brought into close contact with the first outer wall 252 and the first support pipe 253 of the first core housing 250, together, and further, the first cover outer wall 262 and the first cover support pipe 263 of the first core cover 260 are supported against the first outer wall 252 and the first support pipe 253 of the first core housing 250. The first resonant inductor 210 is located firmly in the insertion space of the first core housing 250 by means of the inward fastening force (attractive force) between the first core housing 250 and the first core cover 260.

The second core housing 350 includes a circular flat second plate 351 having a second central hole 351a formed thereon, a second outer wall 352 protruding vertically from the outer periphery of the second plate 351 toward the second resonant inductor 310, a second support pipe 353 protruding upwardly from the inner periphery of the second central hole 351a to form an insertion space between the outer periphery thereof and the second outer wall 352 and having a second through hole 353a communicating with the second central hole 351a, and a second conductive wire guide block 354 having a pair of input and output channels 354a through which the fourth square-shaped adhesion type covered conductive wire 310′ is inserted and drawn in the front side direction in such a way as to stably guide the input and output portions 310i and 310f of the fourth square-shaped adhesion type covered conductive wire 310′ of the second resonant inductor 310 therethrough.

The second core cover 360 includes a circular flat second cover plate 361 having a second cover central hole 361a formed thereon, a second cover outer wall 362 spaced apart from the outer periphery of the second cover plate 361 toward the inner periphery in a radial direction and protruding vertically from the second cover plate 361, a second cover support pipe 363 protruding vertically from the inner periphery of the second cover central hole 361a to form an insertion space between the outer periphery thereof and the second cover outer wall 362 and having a second cover through hole 363a communicating with the second cover central hole 361a, and a second cover conductive wire guide block 364 fitted to the second conductive wire guide block 354 and having a pair of input and output channels 364a through which the fourth square-shaped adhesion type covered conductive wire 310′ is inserted and drawn in the front side direction in such a way as to stably guide the input and output portions 310i and 310f of the fourth square-shaped adhesion type covered conductive wire 310′ of the second resonant inductor 310 therethrough.

As the second cover outer wall 362 of the second core cover 360 is spaced apart from the outer periphery of the second cover plate 361 toward the inner periphery in the radial direction, the second core cover 360 has a second cover outer support rib 366a along the outer periphery of the second cover plate 361 in such a way as to fittedly support the second outer wall 352, and as the second cover support pipe 363 of the second core cover 360 is spaced apart from the inner periphery of the second cover central hole 361a toward the outer periphery in the radial direction, further, the second core cover 360 has a second cover inner support rib 366b along the inner periphery of the second cover plate 361 in such a way as to fittedly support the second support pipe 353.

The second outer wall 352 has an outer support projection 352c on the inner peripheral surface thereof, and the second support pipe 353 has an inner support projection 353c on the inner peripheral surface thereof.

The second cover outer support rib 366a and the second cover inner support rib 366b of the second core cover 360 are fittedly brought into close contact with the second outer wall 352 and the second support pipe 353 of the second core housing 350, together and further, the second cover outer wall 362 and the second cover support pipe 363 of the second core cover 360 are supported against the second outer wall 352 and the second support pipe 353 of the second core housing 350.

The second resonant inductor 310 is located firmly in the insertion space of the second core housing 350 by means of the inward fastening force (attractive force) between the second core housing 350 and the second core cover 360.

Under such a simple configuration, the first resonant inductor 210 and the second resonant inductor 310 are inserted into the first and second core housings 250 and 350, without any movements or gaps, and further, they are reliably insulated from each other.

Further, the main cover 160 and the shielding mount 170 are stably mounted in the main housing 150.

According to the embodiment of the present disclosure, the first core cover 260 has a pair of first outer core movement prevention protrusions 267 protruding from the outer surface of the first cover plate 261 in such a way as to hold the first resonant base 221 of the first resonant outer core 220, so that the first resonant outer core 220 brought into close contact with the first cover plate 261 of the firs core cover 260 is prevented from moving or having a gap, and the first core housing 250 has a pair of first inner core movement prevention protrusions 257 protruding from the outer surface of the first plate 251 in such a way as to hold the first resonant inner core 230, so that the first resonant inner core 230 brought into close contact with the first plate 251 of the first core housing 250 is prevented from moving or having a gap. Further, the second core cover 360 has a pair of second outer core movement prevention protrusions 367 protruding from the outer surface of the second cover plate 361 in such a way as to hold the second resonant base 321 of the second resonant outer core 320, so that the second resonant outer core 320 brought into close contact with the second cover plate 361 of the second core cover 360 is prevented from moving or having a gap, and the second core housing 350 has a pair of second inner core movement prevention protrusions 357 protruding from the outer surface of the second plate 351 in such a way as to hold the second resonant inner core 330, so that the second resonant inner core 330 brought into close contact with the second plate 351 of the second core housing 350 is prevented from moving or having a gap.

According to the present disclosure, further, the transformer 10, the first resonant magnetic cores 220 and 230 coming into close contact with the first main magnetic core 130 of the transformer 10, the first resonant inductor 210 wound inside the first resonant magnetic cores 220 and 230, the second resonant magnetic cores 320 and 330 coming into close contact with the second main magnetic core 140 of the transformer 10, and the second resonant inductor 310 wound inside the second resonant magnetic cores 320 and 330 are inserted into a casing (not shown) and molded integrally with one another by means of insulating resin.

According to the present disclosure, otherwise, the transformer 10, the first resonant magnetic cores 220 and 230 coming into close contact with the first main magnetic core 130 of the transformer 10 in such a way as to allow the first resonant inductor 210 to be wound therein, and the second resonant magnetic cores 320 and 330 coming into close contact with the second main magnetic core 140 of the transformer 10 in such a way as to allow the second resonant inductor 310 to be wound therein are attached to one another by means of adhesion tapes.

In the case of the resonant inductor integrated transformer module 1 according to the present disclosure, the transformer 10 is a transformer for the OBC of the electric vehicle.

As described above, the resonant inductor integrated transformer module according to the present disclosure has the following advantages.
Firstly, the resonant inductors are provided in the transformer itself, so that the resonant inductors have resonance with the capacitance in the transformer itself, thereby providing the transformer with high efficiency and low heat.
Secondly, the resonant inductors are integral with the transformer, so that a space occupied thereby becomes small, thereby being advantageous in designing circuits in a PCB, and if the circuits are designed to have the resonant inductors integral with the transformer, the number of parts and a size of the PCB are reduced.
Thirdly, the resonant inductor integrated transformer module controls the reflection characteristics of electromagnetic waves found at zero-crossing points.
Fourthly, the resonant inductor integrated transformer module emits heat generated from the transformer, while the characteristics of the transformer and the resonant inductors are being still kept, thereby improving heat emission efficiency of the transformer.
Fifthly, the primary and secondary coils of the transformer and the resonant inductors are shielded by magnetic cores, so that perfect resonance is generated, thereby improving the efficiency of the transformer and the temperature characteristics of the transformer.
Sixthly, the primary and secondary coils are formed by winding the first and second square-shaped adhesion type covered conductive wires, which are made by shaping the thin copper wires in the form of a square, covering the insulating sheaths on the outer surfaces of the square-shaped thin copper wires, and applying the bonding layers to the outer surfaces of the insulating sheaths, in such a way as to allow the wound surfaces thereof to be brought into close contact with one another, and fusing and joining the wound surfaces of the first and second square-shaped adhesion type covered conductive wires, so that the primary and secondary coils have high degrees of contact on the wound surfaces thereof and a degree of space utilization for the same number of turns is higher than that when the primary and secondary coils are made with conventional wires.
Seventhly, the transformer for OBC is reduced in volume, thereby decreasing the space occupied thereby on the OBC.
Eighthly, the wound surfaces of the primary and secondary coils have high degrees of contact, so that a degree of space utilization for the same number of turns is higher than that when the primary and secondary coils are made with conventional wires, thereby minimizing a value of leakage current.
Ninthly, no insulation breakdown occurs even at a high voltage in the range of several to tens of kV, while an efficiency between the primary coil and the secondary coil is being kept.
Tenthly, the resonant inductor integrated transformer module supplies large current and high voltage even in small size.
Lastly, the primary and secondary coils are inserted into the main housing, without any movements or gaps, while being reliably insulated from each other, and the first and second resonant inductors are inserted into the first and second core housings, without any movements or gaps, while being reliably insulated from each other.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above teachings. For example, the parts expressed in a singular form may be dispersedly provided, and in the same manner as above, the parts dispersed may be combined with each other.

Accordingly, the present subject matter is not limited to the embodiments described above or depicted in the drawings, and various embodiments and modifications can be made without departing from the scope of the claims below.

What is claimed is:

1. A resonant inductor integrated transformer module comprising:
a transformer (10); and
resonant inductors (210 and 310) as spiral coils located on one side and the other side of the transformer (10) in such a way as to resonate with capacitance in the transformer (10),
wherein the transformer (10) comprises:
a flat primary coil (110) having a first hollow portion (C1) at the central portion thereof; and
a flat secondary coil (120) adapted to generate an induced current by an electric current applied to the primary coil (110) and having a second hollow portion (C2) at the central portion thereof,
whereby the primary coil (110) is formed by winding a first square-shaped adhesion type covered conductive wire (110′) in the form of a coil in such a way as to form the first hollow portion C1 at the central portion thereof,
the first square-shaped adhesion type covered conductive wire (110′) comprising:
stranded thin copper wires (111) made up of multiple thin copper wires (Li) twisted together;
a square thin copper wire bundle (111′) in which the thin copper wires (111) are arrayed to come into close contact with one another in the form of a square;
an insulating sheath (112) covered on the outer surfaces of the square thin copper wire bundle (111′); and
a bonding layer (113) as an adhesive applied to the outer surfaces of the insulating sheath (112),
so that the primary coil (110) is made by winding the first square-shaped adhesion type covered conductive wire (110′) in such a way as to have multiple turns, while allowing the wound surfaces thereof to be brought into close contacts with one another, fusing and curing the applied bonding layer (113), and joining the close contact surfaces of the first square-shaped adhesion type covered conductive wire (110′) by means of the fusing, and
the secondary coil (120) is formed by winding the second square-shaped adhesion type covered conductive wire (120′) in the form of a coil in such a way as to form the second hollow portion (C2) at the central portion thereof,
the second square-shaped adhesion type covered conductive wire (120′) comprising:
stranded thin copper wires (121) made up of multiple thin copper wires (Li) twisted together;
a square thin copper wire bundle (121′) in which the thin copper wires (121) are arrayed to come into close contact with one another in the form of a square;
an insulating sheath (122) covered on the outer surfaces of the square thin copper wire bundle (121)′; and
a bonding layer (123) as an adhesive applied to the outer surfaces of the insulating sheath (122),
so that the secondary coil (120) is made by winding the second square-shaped adhesion type covered conductive wire (120′) in such a way as to have multiple turns, while allowing the wound surfaces thereof to be brought into close contacts with one another, fusing and curing the applied bonding layer (123), and joining the close contact surfaces of the second square-shaped adhesion type covered conductive wire (120′) by means of the fusing.

2. The resonant inductor integrated transformer module according to claim 1, wherein the square thin copper wire bundle (111′) constituting the first square-shaped adhesion type covered conductive wire (110′) is formed by arraying the thin copper wires (111) in up-down and left-right directions in the form of the square in such a way as to be brought into close contact with one another, and the square thin copper wire bundle (121′) constituting the second square-shaped adhesion type covered conductive wire (120′) is formed by arraying the thin copper wires (121) in up-down and left-right directions in the form of the square in such a way as to be brought into close contact with one another.

3. The resonant inductor integrated transformer module according to claim 1, wherein the resonant inductor (210) is a first resonant inductor located on one side of the transformer (10), and the resonant inductor (310) is a second resonant inductor located on the other side of the transformer (10), the first resonant inductor (210) being formed by winding a third square-shaped adhesion type covered conductive wire (210′) in the form of a coil in such a way as to form a third hollow portion (C3) at the central portion thereof, the third square-shaped adhesion type covered conductive wire (210′) comprising:
stranded thin copper wires (211) made up of multiple thin copper wires (Li) twisted together;
a square thin copper wire bundle (211′) in which the thin copper wires (111) are arrayed to come into close contact with one another in the form of a square;
an insulating sheath (212) covered on the outer surfaces of the square thin copper wire bundle (211′); and
a bonding layer (213) as an adhesive applied to the outer surfaces of the insulating sheath (212),
so that the first resonant inductor (210) is formed by winding the third square-shaped adhesion type covered conductive wire (210′) in such a way as to have multiple turns, while allowing the wound surfaces thereof to be brought into close contacts with one another, fusing and curing the applied bonding layer (213), and joining the close contact surfaces of the third square-shaped adhesion type covered conductive wire (210′) by means of the fusing,
the second resonant inductor (310) being formed by winding a fourth square-shaped adhesion type covered conductive wire (310′) in the form of a coil in such a way as to form a fourth hollow portion (C4) at the central portion thereof, and
the fourth square-shaped adhesion type covered conductive wire (310′) comprising:
stranded thin copper wires (311) made up of multiple thin copper wires (Li) twisted together;
a square thin copper wire bundle (311′) in which the thin copper wires (311) are arrayed to come into close contact with one another in the form of a square;
an insulating sheath (312) covered on the outer surfaces of the square thin copper wire bundle (311′); and
a bonding layer (313) as an adhesive applied to the outer surfaces of the insulating sheath (312),
so that the second resonant inductor (310) is formed by winding the fourth square-shaped adhesion type covered conductive wire (310′) in such a way as to have multiple turns, while allowing the wound surfaces thereof to be brought into close contacts with one another, fusing and curing the applied bonding layer (313), and joining the close contact surfaces of the fourth square-shaped adhesion type covered conductive wire (310′) by means of the fusing,
whereby using the first square-shaped adhesion type covered conductive wire (110′) and the third square-shaped adhesion type covered conductive wire (210′) that are provided as a single conductive wire, the primary coil (110) is formed by winding the first square-shaped adhesion type covered conductive wire (110′) in the form of the coil in such a way as to form the first hollow portion (C1) at the central portion thereof, and the first resonant inductor (210) extending from the primary coil (110) is formed by winding the third square-shaped adhesion type covered conductive wire (210′) in the form of the coil in such a way as to form the third hollow portion (C3) at the central portion thereof, so that the first resonant inductor (210) and the primary coil (110) are connected in series with each other, and
using the second square-shaped adhesion type covered conductive wire (120′) and the fourth square-shaped adhesion type covered conductive wire (310′) that are provided as a single conductive wire, the secondary coil (120) is formed by winding the second square-shaped adhesion type covered conductive wire (120′) in the form of the coil in such a way as to form the second hollow portion (C2) at the central portion thereof, and the second resonant inductor (310) extending from the secondary coil (120) is formed by winding the fourth square-shaped adhesion type covered conductive wire (310′) in the form of a coil in such a way as to form the fourth hollow portion (C4) at the central portion thereof, so that the second resonant inductor (310) and the secondary coil (120) are connected in series with each other.

4. The resonant inductor integrated transformer module according to claim 3, wherein the square thin copper wire bundle (211′) constituting the third square-shaped adhesion type covered conductive wire (210′) is formed by arraying the thin copper wires (211) in up-down and left-right directions in the form of the square in such a way as to be brought into close contact with one another, and the square thin copper wire bundle (311′) constituting the fourth square-shaped adhesion type covered conductive wire (310′) is formed by arraying the thin copper wires (311) in up-down and left-right directions in the form of the square in such a way as to be brought into close contact with one another.

5. The resonant inductor integrated transformer module according to claim 4, further comprising:
first resonant magnetic cores (220 and 230) located on the first resonant inductor (210) to increase a magnetic flux density generated by the electric current applied to the first resonant inductor (210); and
second resonant magnetic cores (320 and 330) located on the second resonant inductor (310) to increase a magnetic flux density generated by the electric current applied to the second resonant inductor (310),
wherein the transformer (10) further comprises a first main magnetic core (130) located on the primary coil (110) and a second main magnetic core (140) located on the secondary coil (120) in such a way as to increase magnetic flux densities generated by the induced currents generated from the primary coil (110) and the secondary coil (120), the first resonant magnetic cores (220 and 230) being brought into close contact with the first main magnetic core (130), while the second resonant magnetic cores (320 and 330) being brought into close contact with the second main magnetic core (140),
the first main magnetic core (130) comprises:
a first main base (131) having the shape of a flat plate;
first main outer legs (132) protruding from both outer edges of the first main base (131); and
a first main middle leg (133) spaced apart from the first main outer legs (132) in such a way as to protrude from a central portion of the first main base (131) and be inserted into the first hollow portion (C1) of the primary coil (110),
the second main magnetic core (140) comprises:
a second main base (141) having the shape of a flat plate;
second main outer legs (142) protruding from both outer edges of the second main base (141); and
a second main middle leg (143) spaced apart from the second main outer legs (142) in such a way as to protrude from a central portion of the second main base (141) and be inserted into the second hollow portion (C2) of the secondary coil (120),
the first resonant magnetic core (220) representing a first resonant magnetic outer core comprises:
a first resonant base (221) having the shape of a flat plate;
first resonant outer legs (222) protruding from both outer edges of the first resonant base (221); and
a first resonant middle leg (223) spaced apart from the first resonant outer legs (222) in such a way as to protrude from a central portion of the first resonant base (221) and be inserted into the third hollow portion (C3) of the first resonant inductor (210),
the first resonant magnetic core (230) representing a first second resonant magnetic inner core comes into close contact with the first main base (131) in such a way as to be brought into close contact with the first resonant middle leg (223) and the first resonant outer legs (222) of the first resonant outer core (220) to form a closed magnetic flux, so that a first air gap (g1) is formed between the middle leg (223) of the first resonant outer core (220) and the first resonant inner core (230),
the second resonant magnetic core (320) representing a second resonant magnetic outer core comprises:
a second resonant base (321) having the shape of a flat plate;
second resonant outer legs (322) protruding from both outer edges of the second resonant base (321); and
a second resonant middle leg (323) spaced apart from the second resonant outer legs (322) in such a way as to protrude from a central portion of the second resonant base (321) and be inserted into the fourth hollow portion (C4) of the second resonant inductor (310), and
the second resonant magnetic core (330) representing a second resonant magnetic inner core comes into close contact with the second main base (141) in such a way as to be brought into close contact with the second resonant middle leg (323) and the second resonant outer legs (322) of the second resonant outer core (320) to form a closed magnetic flux, so that a second air gap (g2) is formed between the middle leg (323) of the second resonant outer core (320) and the second resonant inner core (330).

6. The resonant inductor integrated transformer module according to claim 5, wherein the transformer (10), the first resonant magnetic cores (220 and 230) coming into close contact with the first main magnetic core (130) of the transformer (10), the first resonant inductor (210) wound inside the first resonant magnetic cores (220 and 230), the second resonant magnetic cores (320 and 330) coming into close contact with the second main magnetic core (140) of the transformer (10), and the second resonant inductor (310) wound inside the second resonant magnetic cores (320 and 330) are inserted into a casing and molded integrally with one another by means of insulating resin.

7. The resonant inductor integrated transformer module according to claim 5, further comprising:
a main housing (150) inserted into a space between middle legs (133 and 143) and outer legs (132 and 142) of the first and second main magnetic cores (130 and 140), while having a main insertion space (Sa) formed therein to insert the primary coil (110) and the secondary coil (120) thereinto;
a main cover (160) fastened to the main housing (150) in such a way as to open and close the main insertion space (Sa) of the main housing (150);
a shielding mount (170) located inside the main housing (150) to dividedly partition the primary coil (110) and the secondary coil (120) so that the primary coil (110) and the secondary coil (120) are insulated from each other;
a first core housing (250) inserted into a space between the middle legs and outer legs of the first resonant magnetic cores (220 and 230), while inserting the first resonant inductor (210) into an internal space thereof;
a first core cover (260) fastened to the first core housing (250) in such a way as to open and close the first core housing (250);
a second core housing (350) inserted into a space between the middle legs and outer legs of the second resonant magnetic cores (320 and 330), while inserting the second resonant inductor (310) into an internal space thereof; and
a second core cover (360) fastened to the second core housing (350) in such a way as to open and close the second core housing (350),
wherein the primary coil (110) and the secondary coil (120) are fixed to the main insertion space (Sa), without any movements, by means of an inwardly applied force between the main housing (150) and the main cover (160),
the first inductor coil (210) is fixed to the internal space between the first core housing (250) and the first core cover (260), without any movements, by means of an inwardly applied force between the first core housing (250) and the first core cover (260), and
the second inductor coil (310) is fixed to the internal space between the second core housing (350) and the second core cover (360), without any movements, by means of an inwardly applied force between the second core housing (350) and the second core cover (360).

8. The resonant inductor integrated transformer module according to claim 7, wherein the main housing (150) comprises:
a flat bottom (151) having a central hole (151a) formed thereon;
an outer wall (152) protruding upward from the outer periphery of the bottom (151);
a support pipe (153) protruding upward from the inner periphery of the central hole (151a) to form the main insertion space (Sa) between the outer periphery thereof and the outer wall (152) and having a through hole (153a) communicating with the central hole (151a); and
a conductive wire guide block (154) having a pair of input and output channels (154a) through which the first square-shaped adhesion type covered conductive wire (110′) and the second square-shaped adhesion type covered conductive wire (120′) are inserted and drawn in such a way as to stably guide input and output portions of the first square-shaped adhesion type covered conductive wire (110′) of the primary coil (110) and the input and output portions of the second square-shaped adhesion type covered conductive wire (120′) of the secondary coil (120) therethrough,
the shielding mount (170) comprises:
a flat bottom (171) having a central hole (171a) formed thereon;
an outer wall (172) protruding upward from the outer periphery of the bottom (171); and
a support pipe (173) protruding upward from the inner periphery of the central hole (171a) to form a seating space between the outer periphery thereof and the outer wall (172) and having an inner through hole (173a) communicating with the central hole (171a), and
the main cover (160) comprises:
a plate (161) having a central hole (161a) formed thereon;
an outer wall (162) spaced apart from the outer periphery of the plate (161) toward the inner periphery in a radial direction and protruding vertically from the plate (161);
a support pipe (163) protruding vertically from the inner periphery of the central hole (161a) to form the main insertion space (Sa) between the outer periphery thereof and the outer wall (162) and having a through hole (163a) communicating with the central hole (161a); and
a conductive wire guide block (164) fitted to the conductive wire guide block (154) of the main housing (150) and having a pair of input and output channels (164a) through which the second square-shaped adhesion type covered conductive wire (120′) is inserted and drawn in such a way as to stably guide input and output portions of the second square-shaped adhesion type covered conductive wire (120′) of the secondary coil (120) therethrough,
whereby as the outer wall (162) of the main cover (160) is spaced apart from the outer periphery of the plate (161) toward the inner periphery in the radial direction, the main cover (160) has an outer support rib (166a) along the outer periphery of the plate (161) in such a way as to fittedly support the outer wall (152) of the main housing (150);
as the support pipe (163) of the main cover (160) is spaced apart from the inner periphery of the central hole (161a) toward the outer periphery in the radial direction, the main cover (160) has an inner support rib (166b) formed along the inner periphery of the plate (161) in such a way as to fittedly support the support pipe (153) of the main housing (150);
the main housing (150) has an outer support projection (152a) on the inner peripheral surface of the outer wall (152) and an inner support projection (153a) on the inner peripheral surface of the support pipe (153), so that as the outer wall (152) is supported against the outer support projection (152a) and the support pipe (153) is supported against the inner support projection (153), the shielding mount (170) is mounted on the main housing (150) in such a way as to divide the main insertion space (Sa) into a lower insertion space (Sa1) and an upper insertion space (Sa2);
the outer support rib (166a) and the cover inner support rib (166b) of the main cover (160) are supportedly brought into close contact with the outer wall (152) and the support pipe (153) of the main housing (160), together;
the outer wall (162) and the support pipe (163) of the main cover (160) are supported against the outer wall (172) and the support pipe (173) of the shielding mount (170);
the outer wall (152) of the main housing (150) is fitted doubly to the outer wall (162) of the main cover (160) and the outer wall (172) of the shielding mount (170);
the support pipe (153) of the main housing (150) is inserted doubly into the support pipe (163) of the main cover (160) and the support pipe (173) of the shielding mount (170);
the shielding mount (170) is located firmly in the main insertion space (Sa) by means of the inward fastening force between the main housing 150 and the main cover (160); and
the primary coil (110) is located in the lower insertion space (Sal), while the secondary coil (120) is being located in the upper insertion space (Sa2).

9. The resonant inductor integrated transformer module according to claim 7, wherein the first core housing (250) comprises:
a first plate (251) having a first central hole (251a) formed thereon;
a first outer wall (252) protruding vertically from the outer periphery of the first plate (251) toward the first resonant inductor (210);
a first support pipe (253) protruding upward from the inner periphery of the first central hole (251a) to form an insertion space between the outer periphery thereof and the first outer wall (252) and having a first through hole (253a) communicating with the first central hole (251a); and
a first conductive wire guide block (254) having a pair of input and output channels (254a) through which the third square-shaped adhesion type covered conductive wire (210′) is inserted and drawn in such a way as to stably guide input and output portions of the third square-shaped adhesion type covered conductive wire (210′) of the first resonant inductor (210) therethrough, and the first core cover (260) comprises:
a first cover plate (261) having a first cover central hole (261a) formed thereon;
a first cover outer wall (262) spaced apart from the outer periphery of the first cover plate (261) toward the inner periphery in a radial direction and protruding vertically from the first cover plate (261);
a first cover support pipe (263) protruding vertically from the inner periphery of the first cover central hole (261a) to form an insertion space between the outer periphery thereof and the first cover outer wall (262) and having a first cover through hole (263a) communicating with the first cover central hole (261a); and
a first cover conductive wire guide block (264) fitted to the first conductive wire guide block (254) and having a pair of input and output channels (264a) through which the third square-shaped adhesion type covered conductive wire (210′) is inserted and drawn in such a way as to stably guide input and output portions of the third square-shaped adhesion type covered conductive wire (210′) of the first resonant inductor (210) therethrough,
whereby as the first cover outer wall (262) of the first core cover (260) is spaced apart from the outer periphery of the first cover plate (261) toward the inner periphery in the radial direction, the first core cover (260) has a first cover outer support rib (266a) along the outer periphery of the first cover plate (261) in such a way as to fittedly support the first outer wall (252) of the first core housing (250);
as the first cover support pipe (263) of the first core cover (260) is spaced apart from the inner periphery of the first cover central hole (261a) toward the outer periphery in the radial direction, the first core cover (260) has a first cover inner support rib (266b) along the inner periphery of the first cover plate (261) in such a way as to fittedly support the first support pipe (253) of the first core housing (250);
the first outer wall (252) has an outer support projection (252c) on the inner peripheral surface thereof;
the first support pipe (253) has an inner support projection (253c) on the inner peripheral surface thereof;
the first cover outer support rib (266a) and the first cover inner support rib (266b) of the first core cover (260) are fittedly brought into close contact with the first outer wall (252) and the first support pipe (253) of the first core housing (250), together;
the first cover outer wall (262) and the first cover support pipe (263) of the first core cover (260) are supported against the first outer wall (252) and the first support pipe (253) of the first core housing (250); and
the first resonant inductor (210) is located firmly in the insertion space of the first core housing (250) by means of the inward fastening force between the first core housing (250) and the first core cover (260).
